(19) United States
(12) Patent Application Publication
(10) Pub. No.: US 2009/0158896 A1
(43) Pub. Date: Jun. 25, 2009

(54) Monodisperse, Macroporous Chelating Resins in Metal Winning

(76) Inventors: Duilio Rossoni, Langenfeld (DE); Reinhold Klipper, Köln (DE); Bruno Hees, Langenfeld (DE); Rudolf Wagner, Köln (DE); Stefan Neumann, Leverkusen (DE); Olaf Halle, Köln (DE); Wolfgang Podszun, München (DE); Michael Schelhaas, Köln (DE)

Correspondence Address: Nicanor A. Kohncke;Lanxess Corporation, Law & Intellectual Property Department, 111 Ridc Park West Drive, Pittsburgh, PA, 15275-1112, US

(21) Appl. No.: 12/087,632

(22) PCT Filed: Jan. 26, 2007
(86) PCT No.: PCT/EP2007/000678

§ 371 Date: Nov. 5, 2008

(30) Foreign Application Priority Data
Feb. 1, 2006 (DE) 10 2006 004 953.5

(51) Int. Cl. C22B 11/00; C22B 5/00; C08F 8/32

(52) U.S. Cl. 75/744; 75/711; 75/743; 75/721; 525/333.6

(57) ABSTRACT

The present invention relates to the use of monodisperse, macroporous chelating resins in the recovery of metals in hydrometallurgical processes, in particular in resin-in-pulp processes.

The present invention relates to the use of monodisperse, macroporous ion exchangers having chelating groups, hereinafter referred to as monodisperse, macroporous chelating resins, in the recovery of metals in hydrometallurgical processes, in particular in resin-in-pulp processes (R.I.P. processes).

Due to increasing industrialization in many parts of the world and globalization, the demand for numerous metals such as cobalt, nickel, zinc, manganese, copper, gold, silver has increased considerably in recent years. Mining companies and producers of industrial metals are attempting to meet this increasing demand by various measures. These include improvement of the production process itself.

Metals of value which are used in industry occur in ore-bearing rocks which are mined. The ore which is then present in relatively large lumps is milled to produce fine particles. The materials of value can be leached from these rock particles by a number of methods. The customary technique is hydrometallurgy, also referred to as wet metallurgy. A distinction is made between two stages, mainly conversion of the compounds into aqueous metal salt solutions by means of acids or alkalis, if appropriate after pretreatment of the ore, to produce soluble compounds (roasting, pyrogenic treatment). The choice of solvent is determined by the type of metal, its compound present in the ore, the type of materials accompanying the ore (type of gangue) and the price. The most widely used solvent is sulphuric acid, but hydrochloric acid, nitric acid and hot concentrated sodium chloride solutions are also possibilities. In the case of ores having acid-soluble accompanying materials, for example copper, ammoniacal solutions can also be used, sometimes also under high pressure and elevated temperature (pressure leaching). Sodium hydroxide solution is used for the recovery of aluminium oxide, while in the case of noble metals alkali metal cyanide solutions are employed. As an alternative, the recovery of the metals in hydrometallurgy can be effected by precipitation or displacement by means of a less noble metal (cementation), by reduction by means of hydrogen or carbon monoxide at high pressure (pressure precipitation) or by electrolysis using insoluble electrodes or by crystallization (sulphates of copper, of zinc, of nickel or of thallium) or by conversion (precipitation) into sparingly soluble compounds such as hydroxides, carbonates or basic salts by means of chalk, milk of lime or sodium carbonate solution.

U.S. Pat. No. 6,350,420 describes, for example, the treatment of the ore particles with mineral acids such as sulphuric acid at high temperatures (e.g. 250-270° C.) under pressure (high pressure leaching). This gives a suspension (slurry) of the fine ore particles in sulphuric acid in which the metals which have been leached out are present in the form of their salts in more or less concentrated form.

As described above, the leaching of the metals from the rock can also be effected, by other metals. The type of process used depends on a number of factors, for example on the metal content of the ore, on the particle size to which the broken-up ore has been milled or on conditions in terms of apparatus, to name only a few.

In the heap leaching process, relatively coarse ore particles having a low metal content are used.

In the agitation leaching process, finer ore particles (about 200 μm) having high metal contents are used in the leaching process.

However, the atmospheric leaching process or the biooxidation process is also utilized for dissolving the metals from the ores. These processes are cited, for example, in U.S. Pat. No. 6,350,420.

The size of the milled ore particles used in these processes is in the range from about 30 to about 250 μm. Owing to the small size of the particles and the large amount of rock, classical filtration of the particles from the liquid phase via suction or pressure filters is very costly. In industry, separation by the gravitation principle in decanters by settling of the solid phase in very large stirred vessels is employed. To obtain good separation and a virtually particle-free solution of the material of value, stirred vessels having a diameter of 50 metres or more are used and a plurality of these are employed in series. Large amounts of water are necessary, and these are very expensive since many mines are located in regions where there is a shortage of water (deserts). In addition, filtration aids, which are expensive and pollute the environment, often have to be used to achieve better removal of the particles.

In hydrometallurgical plants and mines which are operated in a large number worldwide for the recovery of materials of value such as gold, silver, nickel, cobalt, zinc and other metals, the process steps of filtration and clarification represent a high proportion of the capital costs of the plant and the ongoing operating costs.

Great efforts are therefore being made to replace the abovementioned expensive process steps by other less capital-intensive processes. New processes of this type are carbon-in-pulp processes for silver and gold and resin-in-pulp (R.I.P.) processes for gold, cobalt, nickel and manganese.

The R.I.P. process for the recovery of gold using ion exchangers is described, for example, in C. A. Fleming, Recovery of gold by Resin in pulp at the Golden Jubilee Mine, Precious Metals 89, edited by M. C. Jha and S. D. Hill, TMS, Warrendale, Pa., 1988, 105-119 and in C. A. Fleming, Resin in pulp as an alternative process for gold recovery from cyanide leach slurries, Proceedings of 23 Canadian Mineral Processors conference, Ottawa, January 1991.

L. E. Slobtsov, Resin in Pulp process applied to copper hydrometallurgy, Copper, 91, Volume III, pages 149-154, describes a metallurgical process for the recovery of copper from an ore slurry. An ion exchanger having aminoacetic acid groups is used.

M. W. Johns and A. Mehmet, Proceedings of MINTEK 50: International Conference of Mineral Technology, Randburg, South Africa, 1985, pages 637-645, describe a resin-in-leach process for the extraction of manganese from an oxide. A chelating resin having iminodiacetic acid groups is used as ion exchanger.

U.S. Pat. No. 6,350,420 describes an R.I.P. process for the recovery of nickel and cobalt. A nickel-containing ore is treated with mineral acids in order to leach out the materials of value. The suspension obtained by means of the acid treatment is admixed with ion exchangers which selectively adsorb nickel and cobalt. The laden ion exchangers are separated off from the suspension by means of screens.

In U.S. Pat. No. 6,350,420, resins described in U.S. Pat. No. 4,098,867 and U.S. Pat. No. 5,141,965 are used as ion exchangers. Accordingly, suitable resins are Rohm & Haas IR 904, a strongly basic macroporous anion exchanger, Amberlite XE 318, Dow XFS-43084, Dow XFS-4195 and Dow XFS-4196.

The ion exchangers described in U.S. Pat. No. 4,098,867 and U.S. Pat. No. 5,141,965 contain variously substituted aminopyridine, in particular 2-picolylamine, groups. All ion exchangers described there display a heterodisperse bead diameter distribution. In U.S. Pat. No. 5,141,965, the ion exchangers display bead diameters in the range 0.1-1.5 mm, preferably 0.15-0.7 mm, most preferably 0.2-0.6 mm. The ion exchangers described in U.S. Pat. No. 4,098,867 display bead diameters of 20-50 mesh (0.3 mm-0.850 mm) or larger diameters.

Rohm & Haas IR 904, a strongly basic macroporous anion exchanger, and Amberlite XE 318 are likewise heterodisperse ion exchangers having bead diameters in the range 0.3-1.2 mm. In the examples, screens having mesh openings of 30 or 50 mesh (=300 to 600 μm mesh opening) are used for separating the laden ion exchangers from the rock particles and the leach solution.

However, the processes discussed in the abovementioned prior art have various disadvantages. Thus, it is found that the loading of the ion exchanger beads with the metals, e.g. cobalt and nickel, in the R.I.P. process is not uniform, as a result of which considerable losses of the metals to be recovered occur. Owing to the ion exchangers to be used, further product losses occur when the laden ion exchanger beads are separated off by means of a screen because part of the beads is lost through the screen because of their small diameter. The consequences are both losses of material of value and of ion exchanger beads. Furthermore, washing the fine ore particles out from the fine beads is very time-consuming and requires large amounts of water. Finally, the ion exchangers to be used according to the prior art cause high pressure drops and, owing to the nonuniform loading of the ion exchanger beads,

broad mixing zones occur in the eluates on elution of the metals from the beads, and these are disadvantageous for the further recovery of the individual metals.

According to the prior art, the ion exchangers laden with the metals to be recovered are separated from the fine ore particles and the exhausted solution by means of screens. The mesh opening of the screens has to be such that the laden ion exchanger beads remain on the screen while the ore particles and the solution can flow through it unhindered.

In U.S. Pat. No. 6,350,420, this requires mesh openings of less than 0.1 mm so that no beads pass through the screen and are thus lost. This results both in metal losses and in losses of the ion exchanger used which has to be replaced every now and again.

Screens having mesh openings of 0.3 mm or 0.6 mm are used in the examples of U.S. Pat. No. 6,350,420. Since the ion exchangers having a heterodisperse bead size distribution which are used contain relatively large amounts of beads having diameters below 0.3 mm or 0.6 mm, a relatively large amount of laden ion exchanger is lost by passage through the screens.

Finally, the chelating resins to be used according to U.S. Pat. No. 6,350,420 have bead diameters in the range 0.1-1.5 mm and are thus in virtually the same order of magnitude as the ore particles to be extracted which have a size distribution in the range from 30 μm to 250 μm. It is found that this leads to blockages and to poor separation of the ion exchangers from the particles during screening. The separation process is slowed, relatively large amounts of water are necessary to slurry the particles/ion exchange material and thus be able to effect better screening. The separation process is impaired and can be operated economically only when additional separation apparatuses are employed.

It is therefore an object of the present invention to improve the R.I.P. process so that the above-described disadvantages of the prior art are avoided and a higher yield of metals to be recovered, a lower water consumption, a smaller outlay in terms of apparatus and ultimately an economically improved process are obtained.

This object is achieved by the use of monodisperse ion exchangers, preferably monodisperse, macroporous chelating resins, in the R.I.P. process for the extraction of metals from their ores, which is therefore subject matter of the present invention.

In a preferred embodiment, the monodisperse, macroporous chelating exchangers to be used according to the invention contain functional groups selected from among aminoacetic acid groups and/or iminodiacetic acid groups, aminomethylphosphonic acid groups, thiourea groups, mercapto groups, picolinamino groups and, if appropriate in addition to the chelating group, weak acid groups, preferably carboxyl groups.

The monodisperse, macroporous chelating resins to be used according to the invention surprisingly display, when used in R.I.P. processes, significantly higher yields of metals to be recovered combined with a reduced water consumption, a reduced outlay in terms of apparatus and smaller losses of ion exchangers compared to an R.I.P. process operated according to the prior art using heterodisperse ion exchangers. The monodisperse, macroporous chelating exchangers to be used according to the invention in the R.I.P. process also display, in comparison with heterodisperse ion exchangers, the advantages of a lower pressure drop, higher loading rates, equally long diffusion paths through the beads but with better kinetics, higher separation capacity, sharper separation zones, lower use of chemicals in elution and higher bead stability. A further advantage of the use of monodisperse, macroporous chelating resins in the R.I.P. process is that, due to the jetting process or seed-feed process in the production of the ion exchanger precursor, viz. the monodisperse, macroporous bead polymers, the average bead diameter of the ion exchanger beads can be matched precisely during production to the particle size of the ore and the mesh opening of the screens.

This results in the following advantages:
a) no loss of metals and ion exchanger due to losses through the screen,
b) more uniform, faster loading of the beads with the metal ions,
c) easier separation of the leached ore particles from the ion exchangers during screening, which is reflected in shorter screening times, a lower water consumption, a higher plant capacity,
d) sharp separation zones of the eluted metal ions,
e) lower capital costs.

The production of monodisperse, macroporous chelating resins is known in principle to those skilled in the art. Apart from the fractionation of heterodisperse ion exchangers by screening, a distinction is made essentially between two direct production processes, namely jetting and the seed-feed process in the production of the precursors, viz. the monodisperse bead polymers. In the case of the seed-feed process, a monodisperse feed is used and this can in turn be produced, for example, by screening or by jetting. According to the invention, monodisperse chelating resins produced by the seed-feed process of the jetting process are used.

For the purposes of the present patent application, monodisperse materials are materials in which the uniformity coefficient of the distribution curve is less than or equal to 1.2. The uniformity coefficient is the ratio of the parameters d60 and d 10. D 60 describes the diameter at which 60% by mass of the particles in the distribution curve are smaller and 40% by mass are larger or equal. D 10 refers to the diameter at which 10% by mass of the particles in the distribution curve are smaller and 90% by mass are larger or equal.

The monodisperse bead polymer, viz. the precursor of the ion exchanger, can, for example, be produced by reaction of monodisperse, optionally encapsulated monomer droplets comprising a monovinylaromatic compound, a polyvinylaromatic compound and an initiator or initiator mixture and, if appropriate, a porogen in aqueous suspension. To obtain macroporous bead polymers for the production of macroporous ion exchangers, the presence of a porogen is absolutely necessary. The optionally encapsulated monomer droplet is doped with a (meth)acrylic compound before the polymerization and is subsequently polymerized. In a preferred embodiment of the present invention, microencapsulated monomer droplets are therefore used for the synthesis of the monodisperse bead polymer. The various production processes for monodisperse bead polymers both by the jetting principle and by the seed-feed principle are known to those skilled in the art from the prior art. Reference may at this point be made to U.S. Pat. No. 4,444,961, EP-A 0 046 535, U.S. Pat. No. 4,419,245 and WO 93/12167.

The functionalization of the bead polymers which can be obtained according to the prior art to form monodisperse, macroporous chelating resins is likewise largely known to those skilled in the art from the prior art.

Thus, for example, EP-A 1078690 describes a process for producing monodisperse ion exchangers having chelating, functional groups by the phthalimide process, in which
a) monomer droplets of at least one monovinylaromatic compound and at least one polyvinylaromatic compound and, if appropriate, a porogen and/or, if appropriate, an initiator or an initiator combination are reacted to form a monodisperse, crosslinked bead polymer,
b) this monodisperse, crosslinked bead polymer is amidomethylated by means of phthalimide derivatives,
c) the amidomethylated bead polymer is converted into an aminomethylated bead polymer and
d) the aminomethylated bead polymer is allowed to react to form ion exchangers having chelating groups.

The monodisperse, macroporous chelating exchangers produced as described in EP-A 1078690 bear the chelating groups

—(CH₂)ₙ—NR₁R₂

formed during process step d), where
R₁ is hydrogen or a CH₂—COOH or CH₂P(O)(OH)₂ radical,
R₂ is a CH₂COOH or CH₂P(O)(OH)₂ radical and
n is an integer in the range from 1 to 4.

During the further course of the present patent application, such chelating resins will be referred to as resins having aminoacetic acid groups and/or iminodiacetic acid groups or aminomethylphosphonic acid groups.

The production of monodisperse, macroporous chelating resins by the chloromethylation process is described in U.S. Pat. No. 4,444,961. Here, haloalkylated polymers are aminated and the aminated polymer is reacted with chloroacetic acid to form chelating resins of the iminodiacetic acid type. Monodisperse, macroporous chelating resins having aminoacetic acid groups and/or iminodiacetic acid groups are obtained analogously. Chelating resins having aminoacetic acid groups and/or iminodiacetic acid groups can also be obtained by reaction of chloromethylated bead polymers with iminodiacetic acid.

Furthermore, thiourea groups can be present in the chelating exchanger. The synthesis of monodisperse, macroporous chelating exchangers having thiourea groups is known to those skilled in the art from U.S. Pat. No. 6,329,435, in which amino-methylated bead polymers are reacted with thiourea. Chelating exchangers having thiourea groups can also be obtained by reaction of chloromethylated bead polymers with thiourea.

Chelating exchangers having SH groups (mercapto groups) are likewise well-suited for the R.I.P. process according to the invention. These resins can be obtained in a simple manner by hydrolysis of the last-named chelating exchangers having thiourea groups.

However, monodisperse, macroporous chelating exchangers having additional acid groups can also be used according to the invention in the R.I.P. process. WO 2005/049190 describes the synthesis of monodisperse chelating resins containing both carboxyl groups and —(CH₂)ₘNR₁R₂ groups by reacting monomer droplets of a mixture of a monovinylaromatic compound, a polyvinylaromatic compound, a (meth)acrylic compound, an initiator or an initiator combination and, if appropriate, a porogen to form a crosslinked bead polymer, functionalizing the bead polymer obtained with chelating groups and in this step converting the copolymerized (meth)acrylic compounds into (meth)acrylic acid groups, where
m is an integer from 1 to 4,
R₁ is hydrogen or a CH₂—COOR₃ or CH₂P(O)(OR₃)₂ or —CH₂—S—CH₂COOR₃ or —CH₂—S—C₁-C₄-alkyl or —CH₂—S—CH₂CH(NH₂)COOR₃ or

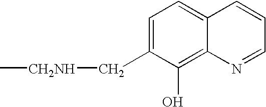

or a derivative thereof or C═S(NH₂) radical,
R₂ is a CH₂COOR₃ or CH₂P(O)(OR₃)₂ or —CH₂—S—CH₂COOR₃ or —CH₂—S—C₁C₄ alkyl or —CH₂—S—CH₂CH(NH₂)COOR₃ or

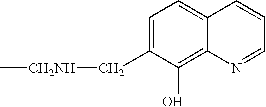

or a derivative thereof or C═S(NH2) radical and
R₃ is H or Na or K.

Monodisperse, macroporous chelating resins having weakly basic groups, namely picolinamine resins, are novel and have not previously been described. The present patent application therefore also provides a process for producing chelating resins containing picolinamino groups, characterized in that
a) a monodisperse, macroporous bead polymer based on styrene, divinylbenzene and ethylstyrene is produced as described in the above-described prior art either by jetting or by a seed-feed process,
b) this monodisperse, macroporous bead polymer is amidomethylated,
c) the amidomethylated bead polymer is converted in an alkaline medium into an aminomethylated bead polymer and
d) the aminomethylated bead polymer is functionalized by reaction with picolyl chloride hydrochloride and if appropriate additionally with ethylene oxide or chloroethanol to form the desired monodisperse, macroporous chelating exchanger having picolinamino groups.

This novel chelating resin can also be used according to the invention in the R.I.P. process, which is likewise subject matter of the present invention, and the monodisperse, macroporous chelating resins having picolinamino groups themselves are similarly subject matter of the present invention. These can be obtained by
a) producing a monodisperse, macroporous bead polymer based on styrene, divinylbenzene and ethylstyrene as described in the above-described prior art either by jetting or by a seed-feed process,
b) amidomethylating this monodisperse, macroporous bead polymer,
c) converting the amidomethylated bead polymer in alkali medium into an aminomethylated bead polymer and
d) functionalizing the aminomethylated bead polymer by reaction with picolyl chloride hydrochloride and if appropriate additionally with ethylene oxide or chloroethanol to form the desired monodisperse chelating exchanger having picolinamino groups.

The optional additional use of ethylene oxide or chloroethanol leads to chelating exchangers having N-(2-hydroxyethyl)-2-picolylamine groups. Without the use of ethylene oxide or chloroethanol, chelating exchangers bearing only bis(2-picolyl)-amine groups are obtained in step d).

This novel chelating resin can be macroporous or gel-like depending on the use of a porogen in the synthesis of the bead polymer in step a). However, the macroporous, monodisperse chelating resins containing picolinamino groups are preferred according to the invention for the R.I.P. process.

The bead diameter of the monodisperse, macroporous chelating resins to be used according to the invention in the R.I.P. process can be matched in process engineering terms to the mesh opening of the screens to be used in the R.I.P. process. The mesh opening of the screens is usually in the range from about 300 μm to 600 μm. The size of the ore particles themselves should be smaller than the mesh opening of the screens, which firstly requires appropriate pretreatment of the ores by milling or acid treatment. For use in the R.I.P. process, the size of the milled ore particles is usually in the range from about 30 to about 250 μm. To achieve these particle sizes of the ores to be processed, the ores are subjected to a variety of milling, dissolution (leaching) or extraction processes. A selection of the ore processing methods which are customarily used is described in the references cited above. For a very high proportion of the metals to be able to be separated off by means of the monodisperse, macroporous chelating resins, the leached ore particles therefore have to pass the screen (or the screens) while at the same time the ion exchanger laden with the metals to be recovered is filtered off as completely as possible from the sulphuric acid solution which is preferably used in the R.I.P. process. According to the invention, it has been found that monodisperse, macroporous chelating resins having an average bead diameter in the range from 0.35 to 1.5 mm, preferably 0.45-1.2 mm, particularly preferably 0.55-1.0 mm, are most suitable. The bead diameters indicated are based on the commercial or supplied form. When the resins are loaded with polyvalent metals, as takes place in the R.I.P. process, the bead diameter decreases slightly, in many cases by about 4-10%.

The monodisperse, macroporous chelating exchangers to be used according to the invention are preferably introduced under atmospheric pressure into the ore particle suspension obtained after the acid treatment in the R.I.P. process. After addition of the chelating exchangers is complete, the resulting suspension containing chelating exchangers is stirred for from 5 minutes to 10 hours, preferably from 15 minutes to 3 hours, as contact time.

The temperature at which the ion exchangers are brought into contact with the ore particle suspension obtained after the acid treatment in the R.I.P. process can be chosen freely over a wide range. It is in the range from ambient temperature to 160° C. Preference is given to temperatures in the range 60-90° C. In general, the process is carried out at atmospheric pressure.

However, it has been found that the higher the temperature in the treatment, the faster does the loading of the chelating exchanger with the metals to be recovered occur.

While the chelating resin is in contact with the suspension, the pH of the suspension is increased by addition of neutralizing agents. The optimum pH is generally from 1 to 6, preferably from 2.5 to 4.5, and can easily be determined by simple preliminary tests.

Suitable neutralizing agents are, for example, milk of lime, magnesium hydroxide or sodium hydroxide.

The contacting of suspension and chelating resin can be carried out in one step. However, it is particularly advantageous to employ a multistage process, e.g. in the form of a cascade process. The cascade process can be carried out in cocurrent or in countercurrent. This means that the ion exchanger and the metal-containing suspension are conveyed through the plant in the same direction or in opposite directions. According to the invention, the countercurrent process is preferred since it leads to particularly effective recovery of the metal contents in the ore.

The eluted chelating resin can be used for further loading/stripping cycles. In the case of the cascade process carried out in countercurrent, it is recirculated directly to the circuit.

The metal to be recovered is separated from the laden chelating exchanger by elution with mineral acids such as sulphuric acid or hydrochloric acid. The concentration of the mineral acids is in the range from 1 to 30% by weight, preferably from 6 to 15% by weight. The metal can also be separated off from the chelating resin by means of complexing solutions such as ammoniacal solutions. The metal-containing solution obtained is generally subjected to further purification processes as are customarily employed in metal recovery.

Metals to be recovered according to the invention by means of monodisperse, macroporous chelating resins in the R.I.P. process belong to main groups III to VI and transition groups 5 to 12 of the Periodic Table of the Elements. Metals which are preferably recovered by means of monodisperse, macroporous chelating exchangers in the R.I.P. process according to the invention are mercury, iron, titanium, chromium, tin, cobalt, nickel, copper, zinc, lead, cadmium, manganese, uranium, bismuth, vanadium, elements of the platinum group, e.g. ruthenium, osmium, iridium, rhodium, palladium, platinum, and also the noble metals gold and silver. Particular preference is given to recovering cobalt, nickel, copper, zinc, rhodium, gold and silver in this way.

If chromate ions are present in the suspension, it is advantageous to reduce the chromate to Cr 3+ in order to avoid oxidative damage to the chelating resin. This reduction can be effected, for example, by addition of SO₂, H₂SO₃, Na₂SO₃, Fe²⁺, Fe, Al, Mg or mixtures thereof.

Fe³⁺ ions can also have a damaging effect on the chelating resin and should therefore be separated off by methods known to those skilled in the art.

If copper-containing suspensions are present in the recovery of Ni/Co by the R.I.P. process, it can be advantageous to remove the copper before introduction of the ion exchanger. This can be achieved, for example, either by cementation by means of zinc, aluminium or iron or by precipitation as sulphide.

However, the present invention also provides a process for recovering metals from their ores by the resin-in-pulp principle, characterized in that
a) a metal-containing ore which has optionally been treated beforehand by roasting or by pyrogenic processing is milled to particles having a size of less than 0.5 mm and the milled ore is admixed with acids, preferably sulphuric acid, hydrochloric acid, nitric acid or mixtures thereof, to leach out the metals to be recovered,
b) after a time selected according to the particular ore to be leached, the pH of the suspension is adjusted towards neutrality by means of a neutralizing agent,
c) a monodisperse, macroporous chelating exchanger is introduced into the suspension,
d) after a further contact time to be determined according to the metal to be recovered, the metal-laden chelating resin is filtered off from the accompanying material by means of a screen and is, if appropriate, washed to remove residual particles,
e) the metal is separated off from the chelating exchanger by elution with mineral acids such as sulphuric acid or hydrochloric acid or with complexing solutions such as ammoniacal solutions and is subjected to further purification processes as are customarily employed in metal recovery.

Ores to be used according to the invention are laterite ores, limonite ores, pyrrhotite, smaltine, cobaltine, linneite, magnetic pyrite and other ores containing iron, nickel, cobalt, copper, zinc, silver, gold, titanium, chromium, tin, magnesium, arsenic, manganese, aluminium, other platinum metals, noble metals or heavy metals or alkaline earth metals.

### EXAMPLES

### Example 1

### Production of a Monodisperse, Macroporous Chelating Resin Containing Picolinamino Groups

### a) Production of the Monodisperse, Macroporous Bead Polymer Based on Styrene, Divinylbenzene and Ethylstyrene as Described in EP-A 1078690:

3000 g of deionized water are placed in a 10 l glass reactor and a solution of 10 g of gelatin, 16 g of disodium hydrogen phosphate dodecahydrate and 0.73 g of resorcinol in 320 g of deionized water is added and the mixture is mixed. The mixture is maintained at 25° C. While stirring, a mixture of 3200 g of microencapsulated monomer droplets having a narrow particle size distribution and produced from a monomer mixture of 3.6% by weight of divinylbenzene and 0.9% by weight of ethylstyrene (used as commercial isomer mixture of divinylbenzene and ethylstyrene containing 80% of divinylbenzene), 0.5% by weight of dibenzoyl peroxide, 56.2% by weight of styrene and 38.8% by weight of isododecane (industrial isomer mixture having a high proportion of pentamethylheptane) is subsequently added. The microcapsule comprises a formaldehyde-hardened complex coacervate of gelatin and a copolymer of acrylamide and acrylic acid. Finally, 3200 g of aqueous phase having a pH of 12 are added. The average particle size of the monomer droplets is 460 μm.

The mixture is polymerized by stirring by increasing the temperature according to a temperature programme commencing at 25° C. and ending at 95° C. The mixture is cooled, washed on a 32 μm screen and subsequently dried at 80° C. under reduced pressure. This gives 1893 g of a spherical bead polymer having an average particle size of 440 μm, a narrow particle size distribution and a smooth surface.

The bead polymer is chalky white in appearance and has a bulk density of about 370 g/l.

### 1b) Production of the Monodisperse, Amidomethylated Bead Polymer

2400 ml of dichloroethane, 595 g of phthalimide and 413 g of 30.0% strength by weight of formalin are placed in a reaction vessel at room temperature. The pH of the suspension is set to 5.5-6 by means of sodium hydroxide. The water is subsequently removed by distillation. 43.6 g of sulphuric acid are then introduced. The water formed is removed by distillation. The mixture is cooled. At 30° C., 174.4 g of 65% strength oleum are introduced, followed by 300.0 g of monodisperse bead polymer produced as described in process step 1a). The suspension is heated to 70° C. and stirred at this temperature for a further 6 hours. The reaction liquid is taken off, deionized water is added and residual amounts of dichloroethane are removed by distillation.

Yield: 1820 ml of amidomethylated bead polymer

Elemental analysis: carbon: 75.3% by weight; hydrogen: 4.6% by weight; nitrogen: 5.75% by weight.

### 1c) Production of the Monodisperse, Aminomethylated Bead Polymer

851 g of 50% strength by weight sodium hydroxide solution and 1470 ml of deionized water are added to 1770 ml of monodisperse, amidomethylated bead polymer from Example 1b) at room temperature. The suspension is heated to 180° C. and stirred at this temperature for 8 hours.

The bead polymer obtained is washed with deionized water.

Yield: 1530 ml of aminomethylated bead polymer

The total yield (extrapolated) is 1573 ml

Elemental analysis: carbon: 78.2% by weight; hydrogen: 12.25% by weight; nitrogen: 8.4% by weight.

Number of mole of aminomethyl groups per litre of aminomethylated bead polymer: 2.13

An average of 1.3 hydrogen atoms per aromatic ring, derived from the styrene and divinylbenzene units, were replaced by aminomethyl groups.

1d) Conversion of the Monodisperse, Aminomethylated Bead Polymer into a Monodisperse Chelating Resin Having 2-picolylamino Groups

250 ml of the monodisperse, aminomethylated bead polymer produced in Example 1c) are added to 250 ml of deionized water. The suspension is heated at 90° C. for 1 hour. 187 gram of a 50% strength by weight aqueous solution of 2-picolyl chloride hydrochloride in water are then introduced at 90° C. over a period of 4 hours. The pH is maintained at 9.2 by addition of 50% strength by weight sodium hydroxide solution.

The temperature is then increased to 95° C. The pH is increased to 10.5 by introduction of sodium hydroxide solution. The mixture is stirred at 95° C. and a pH of 10.5 for a further 6 hours.

The suspension is cooled; the liquid phase is separated off on a screen and the beads are washed with water.

Yield: 330 ml

50 ml of bead polymer weigh 17.4 gram when dry

Elemental analysis:

Carbon: 78.6% by weight;

Nitrogen: 13.0% by weight;

Hydrogen: 6.9% by weight;

Quantity of weakly basic groups: 2.05 mol/l

Volume of the beads in the commercial form: 100 ml

Volume of the beads in the chloride form: 140 ml

### Example 2

### Production of a Monodisperse Chelating Resin Having Aminoacetic Acid Groups and/or Iminodiacetic Acid Groups

### 2a) Production of the Monodisperse, Macroporous Bead Polymer Based on Styrene, Divinylbenzene and Ethylstyrene

3000 g of deionized water are placed in a 10 l glass reactor and a solution of 10 g of gelatin, 16 g of disodium hydrogen phosphate dodecahydrate and 0.73 g of resorcinol in 320 g of deionized water is added and the mixture is mixed. The mixture is maintained at 25° C. While stirring, a mixture of 3200 g of microencapsulated monomer droplets having a narrow particle size distribution and produced from a monomer mixture of 3.6% by weight of divinylbenzene and 0.9% by weight of ethylstyrene (used as commercial isomer mixture of divinylbenzene and ethylstyrene containing 80% of divinylbenzene), 0.5% by weight of dibenzoyl peroxide, 56.2% by weight of styrene and 38.8% by weight of isododecane (industrial isomer mixture having a high proportion of pentamethylheptane) is subsequently added. The microcapsule comprises a formaldehyde-hardened complex coacervate of gelatin and a copolymer of acrylamide and acrylic acid. Finally, 3200 g of aqueous phase having a pH of 12 are added. The average particle size of the monomer droplets is 460 μm.

The mixture is polymerized by stirring by increasing the temperature according to a temperature programme commencing at 25° C. and ending at 95° C. The mixture is cooled, washed on a 32 μm screen and subsequently dried at 80° C. under reduced pressure. This gives 1893 g of a spherical bead polymer having an average particle size of 440 μm, a narrow particle size distribution and a smooth surface.

The bead polymer is chalky white in appearance and has a bulk density of about 370 g/l.

### 2b) Production of the Monodisperse, Amidomethylated Bead Polymer

2267 ml of dichloroethane, 470.4 g of phthalimide and 337 g of 29.1% strength by weight of formalin are placed in a reaction vessel at room temperature. The pH of the suspension is set to 5.5-6 by means of sodium hydroxide. The water is subsequently removed by distillation. 34.5 g of sulphuric acid are then introduced. The water formed is removed by distillation. The mixture is cooled. At 30° C., 126 g of 65% strength oleum are introduced, followed by 424.4 g of monodisperse bead polymer produced as described in process step 2a). The suspension is heated to 70° C. and stirred at this temperature for a further 6 hours. The reaction liquid is taken off, deionized water is added and residual amounts of dichloroethane are removed by distillation.

Yield: 1880 ml of amidomethylated bead polymer

50 ml of tapped moist resin weigh 23.2 gram when dry.

Elemental analysis:

Carbon: 78.5% by weight;

Hydrogen: 5.3% by weight;

Nitrogen: 4.8% by weight;

Balance: oxygen

### 2c) Production of the Monodisperse, Aminomethylated Bead Polymer

733.8 g of 50% strength by weight sodium hydroxide solution and 1752 ml of deionized water are added to 1860 ml of amidomethylated bead polymer from Example 2b) at room temperature. The suspension is heated to 180° C. and stirred at this temperature for 6 hours.

The bead polymer obtained is washed with deionized water.

Yield of aminomethylated bead polymer: 1580 ml

Elemental analysis:

Carbon: 82.2% by weight;

Hydrogen: 8.4% by weight;

Nitrogen: 7.8% by weight;

Balance: oxygen

It can be calculated from the elemental analysis of the aminomethylated bead polymer that an average of 0.82 hydrogen atoms per aromatic ring, derived from the styrene and divinylbenzene units, have been replaced by aminomethyl groups.

### 2d) Production of the Monodisperse Ion Exchanger Having Chelating Groups

1520 ml of aminomethylated bead polymer from Example 2c) are added to 1520 ml of deionized water at room temperature. The suspension is heated to 90° C. 713.3 g of monochloroacetic acid are introduced at 90° C. over a period of 4 hours. During this addition, the pH is maintained at 9.2 by addition of 50% strength by weight sodium hydroxide solution. The suspension is subsequently heated to 95° C. and the pH is set to 10.5. The suspension is stirred at this temperature for a further 6 hours.

The suspension is then cooled. The resin is washed with deionized water until free of chloride.

Yield: 2885 ml

Total capacity of the resin: 2.0 mol/l of resin

The average bead diameter is 602 μm.

The uniformity coefficient is 1.04. The unity coefficient is 0.586.

97% by volume of all beads have a bead diameter in the range from 0.500 to 0.71 mm.

### Example 3

### Production of a Heterodisperse Chelating Resin Having Amino-Acetic Acid Groups and/or Iminodiacetic Acid Groups (not According to the Invention)

### 3a) Production of the Monodisperse, Macroporous Bead Polymer Based on Styrene, Divinylbenzene and Ethylstyrene

1200 ml of an aqueous liquor are placed in a 3 litre glass reactor. The liquor contains 1.4 gram of a protective colloid based on cellulose and 10 gram of disodium hydrogen phosphate in solution. 1526 gram of a solution comprising 566 gram of isododecane, 96 gram of 80% strength by weight divinylbenzene, 864 gram of styrene and 7.7 gram of dibenzoyl peroxide are added thereto. The mixture is stirred at room temperature for 30 minutes. It is then heated to 70° C. over a period of one hour and stirred at 70° C. for a further 7 hours. It is subsequently heated to 90° C. and stirred at this temperature for a further 2 hours. The mixture is then cooled, the bead polymer obtained is separated off by means of a screen, washed with water and finally dried.

Sieve analysis of the bead polymer:

0-0.2 mm: 3% by weight

0.2-0.26 mm: 4% by weight

0.26-0.32 mm: 8% by weight

0.32-0.4 mm: 11% by weight

0.4-0.56 mm: 9% by weight

0.56-0.62 mm: 31% by weight

0.62-0.8 mm: 34% by weight

### 3b) Production of the Heterodisperse Amidomethylated Bead Polymer

2267 ml of dichloroethane, 470.4 g of phthalimide and 337 g of 29.1% strength by weight of formalin are placed in a reaction vessel at room temperature. The pH of the suspension is set to 5.5-6 by means of sodium hydroxide. The water is subsequently removed by distillation. 34.5 g of sulphuric acid are then introduced. The water formed is removed by distillation. The mixture is cooled. At 30° C., 126 g of 65% strength oleum are introduced, followed by 424.0 g of monodisperse bead polymer produced as described in process step 3a). The suspension is heated to 70° C. and stirred at this temperature for a further 6 hours. The reaction liquid is taken off, deionized water is added and residual amounts of dichloroethane are removed by distillation.

Yield: 1830 ml of amidomethylated bead polymer

Elemental analysis:

Carbon: 78.0% by weight;

Hydrogen: 5.3% by weight;

Nitrogen: 5.2% by weight;

Balance: oxygen

### 3c) Production of the Heterodisperse Aminomethylated Bead Polymer

725 g of 50% strength by weight sodium hydroxide solution and 1752 ml of deionized water are added to 1800 ml of monodisperse, amidomethylated bead polymer from Example 3b) at room temperature. The suspension is heated to 180° C. and stirred at this temperature for 6 hours.

The bead polymer obtained is washed with deionized water.

Yield: 1520 ml of aminomethylated bead polymer

Elemental analysis:

Carbon: 82.2% by weight;

Hydrogen: 8.3% by weight;

Nitrogen: 8.2% by weight;

Balance: oxygen

It can be calculated from the elemental analysis of the aminomethylated bead polymer that an average of 0.78 hydrogen atoms per aromatic ring, derived from the styrene and divinylbenzene units, have been replaced by aminomethyl groups.

### 3d) Production of the Heterodisperse Ion Exchanger Having Chelating Groups

1500 ml of aminomethylated bead polymer from Example 3c) are added to 1500 ml of deionized water at room temperature. The suspension is heated to 90° C. 705 g of monochloroacetic acid are introduced at 90° C. over a period of 4 hours. During this addition, the pH is maintained at 9.2 by addition of 50% strength by weight sodium hydroxide solution. The suspension is subsequently heated to 95° C. and the pH is set to 10.5. The suspension is stirred at this temperature for a further 6 hours.

The suspension is then cooled. The resin is washed with deionized water until free of chloride.

Yield: 2730 ml

Total capacity of the resin: 2.05 mol/l of resin

Sieve analysis of the chelating resin:

| | |
|---|---|
| 0.315-0.4 mm: | 5 percent by volume |
| 0.4-0.55 mm: | 23 percent by volume |
| 0.55-0.66 mm: | 33 percent by volume |
| 0.66-0.80 mm: | 32 percent by volume |
| 0.8-1.1 mm: | 7 percent by volume |

### Example 4

### Not According to the Invention

500 ml of a suspension (solids content: 25% by weight) of an ore in sulphuric acid is stirred at 270° C. under pressure for 2 hours. The mixture is cooled and depressurized. The pH of the suspension is set to 2.5 by means of 50% strength by weight sodium hydroxide solution. 25 ml of a heterodisperse, macroporous chelating resin having iminodiacetic acid groups (see Example 3) are subsequently added. The suspension is stirred at room temperature for 5 hours.

The ion exchanger is then separated off from the suspension. The concentration of nickel and cobalt ions in the suspension before and after treatment with the ion exchanger is measured—see Table 1.

### Example 5

500 ml of a suspension (solids content: 25% by weight) of an ore in sulphuric acid is stirred at 270° C. under pressure for 2 hours. The mixture is cooled and depressurized. The pH of the suspension is set to 2.5 by means of 50% strength by weight sodium hydroxide solution. 25 ml of a monodisperse, macroporous chelating resin having iminodiacetic acid groups (see Example 2) are subsequently added. The suspension is stirred at room temperature for 5 hours.

The ion exchanger is then separated off from the suspension. The concentration of nickel and cobalt ions in the suspension before and after treatment with the ion exchanger is measured—see Table 1.

The results in Table 1 clearly show that, surprisingly, a monodisperse chelating resin is able to remove nickel and/or cobalt ions from a leach suspension in larger amounts than a heterodisperse chelating resin according to the prior art.

TABLE 1

| | Cobalt concentration in | Nickel concentration in | Cobalt concentration in | Nickel concentration in |
|---|---|---|---|---|
| | the suspension before | the suspension before | the suspension after | the suspension after |
| | treatment with the ion | treatment with the ion | treatment with the ion | treatment with the ion |
| | exchanger in gram/ | exchanger in gram/ | exchanger in gram/ | exchanger in gram/ |
| Resin type | litre of solution | litre of solution | litre of solution | litre of solution |
| Treatment with heterodisperse, | 4.2 | 0.2 | 2.2 | 0.04 |
| macroporous chelating resin | | | | |
| from Example 3 | | | | |
| Treatment according to the | 4.2 | 0.2 | 0.7 | 0 |
| invention with monodisperse, | | | | |
| macroporous chelating resin | | | | |
| from Example 2 | | | | |

### Analytical Methods

### Volume Change Between Chloride/OH Form

100 ml of anion exchanger bearing basic groups (commercial form) are rinsed into a glass column by means of deionized water. 1000 ml of 3% strength by weight hydrochloric acid are filtered through the resin over a period of 1 hour 40 minutes. The resin is subsequently washed with deionized water until it is free of chloride. The resin is rinsed into a tamping volumeter by means of deionized water and tapped until the volume is constant—volume V 1 of the resin in the chloride form. The resin is once again introduced into the column. 1000 ml of 2% strength by weight sodium hydroxide solution are filtered through it. The resin is subsequently washed alkali-free with deionized water until the eluate has a pH of 8. The resin is rinsed into a tamping volumeter by means of deionized water and tapped until the volume is constant—volume V2 of the resin in the free base form (OH form).

Calculation: V1−V2=V3

V3: V1/100=swelling between chloride/OH form in %

### Determination of the Amount of Basic Aminomethyl Groups in the Aminomethylated, Crosslinked Polystyrene Bead Polymer

100 ml of the aminomethylated bead polymer are tapped into a tamping volumeter and subsequently rinsed into a glass column by means of deionized water. 1000 ml of 2% strength by weight sodium hydroxide solution are filtered through the bead polymer over a period of 1 hour 40 minutes. Deionized water is subsequently passed through until 100 ml of eluate admixed with phenolphthalein have a consumption of 0.1 N (0.1 normal) hydrochloric acid of not more than 0.05 ml.

50 ml of this resin are admixed with 50 ml of deionized water and 100 ml of 1N hydrochloric acid in a glass beaker. The suspension is stirred for 30 minutes and subsequently introduced into a glass column. The liquid is drained. A further 100 ml of 1N hydrochloric acid are filtered through the resin over a period of 20 minutes. 200 ml of methanol are subsequently passed through it. All eluates are collected and combined and titrated with 1N sodium hydroxide solution against methyl orange.

The amount of aminomethyl groups in 1 litre of aminomethylated resin is calculated according to the following formula: (200−V)·20=mol of aminomethyl groups per litre of resin.

1. A process for the recovery at least one metal by the resin-in-pulp process, comprising:
a) providing a metal-containing suspension comprising at least one metal; and
b) contacting said suspension comprising at least one chelating exchanger.

2. The process according to claim 1, wherein the monodisperse, macroporous chelating exchanger comprises one or more of aminoacetic acid groups, iminodiacetic acid groups, aminomethylphosphonic acid groups, thiourea groups, mercapto groups, and picolinamino groups.

3. The process according to claim 1, wherein the at least one metal is a metal of the main groups III to VI and transition groups 5 to 12 of the Periodic Table of the Elements.

4. The process according to claim 1, wherein the at least one metal is mercury, iron, titanium, chromium, tin, cobalt, nickel, copper, zinc, lead, cadmium, manganese, uranium, bismuth, vanadium, ruthenium, osmium, iridium, rhodium, palladium, platinum, gold, and silver.

5. The process according to claim 1, wherein the monodisperse, macroporous chelating exchanger has an average bead diameter in the range from 0.35 to 1.6 mm.

6. The process according to claim 1, wherein the monodisperse, macroporous, chelating exchanger is used at temperatures in the range from ambient temperature to 160° C.

7. The process according to claim 1, wherein the process further comprises countercurrent conveying of the monodisperse, macroporous chelating exchanger and the metal-containing suspension.

8. A process for recovering metals from their ores, comprising:
a) milling a metal-containing ore thereby forming a milled ore comprising particles, said particles having a size of less than 0.5 mm, and admixing the milled ore having a size of less than 0.5 mm, and admixing the milled ore with an acid, thereby leaching out the metals to be recovered, whereby a suspension is formed,
b) subsequent to step a), adding a neutralizing agent thereby adjusting the pH of the suspension towards neutrality,
c) contacting the suspension with a monodisperse, macroporous chelating exchanger, thereby forming a metal-laden chelating resin,
d) subsequent to step c), filtering off the metal-laden chelating resin means of a screen, and
e) eluting with mineral acid the metal-laden chelating resin thereby separating the metal of the metal-laden chelating resin from the chelating exchanger.

9. The process according to claim 8, wherein the monodisperse, macroporous chelating exchanger comprises aminoacetic acid groups, iminodiacetic acid groups, aminomethylphosphonic acid groups, thiourea groups, mercapto groups, aminomethylphosphonic acid groups, thiourea groups, mercapto groups, and picolinamino groups.

10. (canceled)

11. The process according to claim 8, wherein the metal-containing ore comprises laterite ores, limonite ores, pyrrhotite, smaltine, cobaltine, linneite, magnetic pyrite and other ores containing iron, nickel, cobalt, copper, zinc, silver, gold, titanium, chromium, tin, magnesium, arsenic, manganese, aluminium, other platinum metals, noble metals, heavy metals, or alkaline earth metals.

12. A process for producing a monodisperse, macroporous chelating resin containing picolinamino groups, comprising:
a) producing a monodisperse, macroporous bead polymer based on styrene, divinylbenzene and ethylstyrene by means of either a jetting or a seed-feed process,
b) amidomethylating the monodisperse, macroporous bead polymer, thereby forming an amidomethylated bead polymer,
c) converting the amidomethylated bead polymer into an aminomethylated bead polymer in an alkaline medium, and
d) the functionalizing the aminomethylated bead polymer reacting the aminomethylated bead polymer with picolyl chloride hydrochloride to form the monodisperse, macroporous chelating exchanger containing picolinamino groups.

13. The monodisperse, macroporous chelating resin containing picolinamino groups obtained according to the process of claim 12.

14. The process according to claim 2, wherein the monodisperse, macroporous chelating exchanger further comprises weak acid groups.

15. The process according to claim 14, wherein the weak acid groups are carboxyl groups.

16. The process according to claim 8, wherein the metal-containing ore of step a) is treated prior to step a) by roasting or pyrogenic processing.

17. The process according to claim 8, wherein the acid of step a) is at least one of sulphuric acid, hydrochloric acid, nitric acid or mixtures thereof.

18. The process according to claim 8, wherein the mineral acid of step e) is at least one sulphuric acid, hydrochloric acid, or mixture thereof.

19. The process according to claim 8, wherein the eluting of step e) is preformed with a complexing solution rather than mineral acid.

20. The process according to claim 19, wherein the complexing solution is an ammoniacal solution.

21. The process according to claim 8, further comprising:
f) further purifying said metal-laden chelating resin.

22. The process according to claim 9, wherein the monodisperse, macroporous chelating exchanger further comprises weak acid groups.

23. The process according to claim 23, wherein the weak acid groups are carboxyl groups.

24. The process according to claim 12, wherein the functionalizing the aminomethylated bead polymer of step d) comprises reacting the aminomethylated bead polymer with picolyl chloride hydrochloride and ethylene oxide or chloroethanol.
